(19) United States
(12) Patent Application Publication
(10) Pub. No.: US 2005/0280744 A1
(43) Pub. Date: Dec. 22, 2005

(54) Broadcast receiving apparatus having combined mode set-up function and method thereof

(76) Inventor: Kil-young Shin, Suwon-si (KR)

Correspondence Address: STANZIONE & KIM, LLP, 919 18TH STREET, N.W., SUITE 440, WASHINGTON, DC, 20006, US

(21) Appl. No.: 11/143,578

(22) Filed: Jun. 3, 2005

(30) Foreign Application Priority Data
Jun. 18, 2004 (KR) 2004-45291

(51) Int. Cl. H04N 5/50

(52) U.S. Cl. 348/738; 348/569

(57) ABSTRACT

A broadcast receiving apparatus having a combined mode set-up function. The broadcast receiving apparatus includes a storage unit to store data required to set up a combined output mode including a video mode to process a video signal of a designated broadcast signal and an audio mode to process an audio signal of the broadcast signal, a user interface (UI) to receive an external operation signal to set the output mode, a video signal processor to process the video signal according to the output mode, an audio signal processor to process the audio signal according to the output mode, and a controller to read from the storage a data to set the output mode that is set up through the UI, and to control the video signal processor and the audio signal processor to process the video signal and the audio signal in accordance with the data. With the above, it becomes possible to combine the audio mode and the video mode.

### CROSS-REFERENCE TO RELATED APPLICATIONS

This application claims benefit under 35 U.S.C. § 119 from Korean Patent Application No. 2004-45291, filed on Jun. 18, 2004, the disclosure of which is incorporated herein in its entirety and by reference.

### BACKGROUND OF THE INVENTION

1. Field of the Invention

The present general inventive concept relates to a broadcast receiving apparatus having a combined mode set-up function and a method thereof, and more specifically, to a broadcast receiving apparatus to set up a combined mode including a video mode and a variety of audio modes, and a method thereof.

2. Description of the Related Art

In a traditional broadcast receiving apparatus, a video mode and an audio mode of a channel are set up, respectively. In other words, to adjust the current video mode of a channel, a viewer operates a remote controller and keypad. Similarly, the viewer has to operate the remote controller and keypad again to adjust the current audio mode of the same channel.

In the video mode, a brightness, a contrast, a color, a color-density, and a sharpness of an output image are set appropriate for a broadcast, such as a movie, a news program, or music, or a brightness of surroundings. Examples of brightness, contrast, color, color-density, and sharpness values in the video mode are illustrated in Table 1 below.

TABLE 1

| | | | | Color- | |
|---|---|---|---|---|---|
| Video mode | Brightness | Contrast | Color | density | Sharpness |
| Standard | 60 | 80 | 0 | 50 | 60 |
| Day | 80 | 100 | 10 | 60 | 80 |
| Night | 50 | 80 | −10 | 60 | 80 |
| User | 70 | 100 | 15 | 55 | 75 |

The standard, day, and night modes are automatically set up by manufacturers of broadcast receiving apparatuses. For example, when a user (or viewer) selects the ‘day’ mode, the brightness, contrast, color, color-density, and sharpness of the output image are automatically set to the values listed in Table 1. In the ‘user’ mode, the user is able to adjust the brightness, contrast, color, color-density, and sharpness of the output image.

In the audio mode, treble and bass of an output sound are set to appropriate values. Examples of treble and bass values in the audio mode are illustrated in Table 2 below.

TABLE 2

| Audio mode | Bass | Treble |
|---|---|---|
| Standard | 50 | 50 |
| Movie | 60 | 45 |
| Music | 55 | 55 |
| User | 65 | 55 |

The standard, movie, and music modes are automatically set up by manufacturers of the broadcast receiving apparatuses. For example, when a user selects the ‘movie’ mode, the bass and treble of an output sound are automatically set to the values listed in Table 2. In the ‘user’ mode, the user is able to adjust the bass and treble of the output sound.

Besides the above-described modes, there are stereo and mono modes that change in accordance with a broadcast signal transmitted from a station. In the stereo mode, two directional microphones are utilized to receive an original sound. And, depending on where those two directional microphones are located, an audio signal of the original sound is received at different intensities and times. As a result, two audio signals are outputted from two speakers, respectively, reproducing a sound closest to the original sound, and giving viewers a presence and stereo sound effect. In the mono mode, on the other hand, one directional microphone is utilized to receive an original sound, and an audio signal therefrom is outputted from two speakers. Thus the mono mode gives viewers a mono, identical output. Lastly, an audio-multiplex broadcasting system transmits to a carrier an audio signal in addition to a broadcast signal corresponding to a selected channel. When an audio-multiplex broadcast program is on, the viewer is allowed to set a preferred language, such as, Korean, a foreign language, or dual languages.

To set a plurality of the above discussed modes, the viewer has to set each of the modes, respectively, using the remote controller and keypad. For example, the viewer must set the video mode and the audio mode separately. And, whenever the channel or the broadcast program is changed, the viewer has to set the video mode and the audio mode each time, which is uncomfortable and inconvenient.

### SUMMARY OF THE INVENTION

The present general inventive concept provides a broadcast receiving apparatus having a combined mode set-up function and a method thereof, whereby a user is able to set a combined mode and reserve the combined mode for a broadcast signal at a desired time.

The present general inventive concept enables a user to combine a video mode and an audio mode in a broadcast receiving apparatus simply by pressing a shortcut key on a remote controller, thereby increasing user convenience.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a broadcast receiving apparatus including a storage unit to store data required to set up a combined output mode including both a video mode to process a video signal of a designated broadcast signal and an audio mode to process an audio signal of the broadcast signal, a user interface (UI) to receive an external operation signal to set the combined output mode, a video signal processor to process the video signal according to the combined output mode, an audio signal processor to process the audio signal according to the combined output mode, and a controller to read from the storage the data to set the combined output mode that is set up through the UI, and to control the video signal processor and the audio signal processor to process the video signal and the audio signal in accordance with the data.

The apparatus may further include an OSD generator to generate an OSD menu and an OSD message, wherein the OSD menu allows a user to set a channel number to select a channel, a broadcasting time of the selected channel, the combined output mode, a stereo function, an audio-multiplex function, and an automatic mode to automatically apply at least one of the combined output mode, the stereo function, and the audio-multiplex function to the broadcast signal of the channel at the broadcasting time, and the OSD message indicates an execution state of the stereo function and/or the audio-multiplex function set to the channel.

The UI may further receive an external operation signal to set at least one of the channel number, the broadcasting time of the selected channel, the stereo function, the audio-multiplex function, and the automatic mode to automatically apply at least one of the combined output mode, the stereo function, and the audio-multiplex function to the broadcast signal of the channel at the broadcasting time.

The apparatus may further include an RTC (Real Time Clock) to indicate a current time and a tuner to select the channel, wherein if the current time sensed through the RTC coincides with the broadcasting time, the controller controls the tuner to select the channel and, the audio signal processor to apply to the broadcast signal at least one of the stereo function and the audio-multiplex function.

The foregoing and/or other aspects and advantages of the present general inventive concept may also be achieved by providing a combined mode set-up method of a broadcast receiving apparatus, the combined mode setup method including storing data required to set up a combined output mode including both a video mode to process a video signal of a designated broadcast signal and an audio mode to process an audio signal of the broadcast signal, receiving an external operation signal to set up the combined output mode, in accordance with the external operation signal, reading the data to set up the combined output mode, and in accordance with the data, processing the video signal and the audio signal.

The method may further include displaying an OSD menu enabling a user to set a channel number to select a channel, a broadcasting time of the selected channel, the combined output mode, a stereo function, an audio-multiplex function, and an automatic mode to automatically apply at least one of the combined output mode, the stereo function, and the audio-multiplex function to the broadcast signal of the channel at the broadcasting time, and displaying an OSD message indicating an execution state of the stereo function and/or the audio-multiplex function set to the channel.

The receiving of the external operation signal may include setting up at least one of the channel number, the broadcasting time of the selected channel, the stereo function, the audio-multiplex function, and the automatic mode to automatically apply at least one of the combined output mode, the stereo function, and the audio-multiplex function to the broadcast signal of the channel at the broadcasting time.

The method may further include comparing the broadcasting time with a current time, and if the current time coincides with the broadcasting time, selecting the channel and applying to the broadcast signal at least one of the stereo function and the audio-multiplex function.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic block diagram of a broadcast receiving apparatus according to an embodiment of the present general inventive concept;

FIG. 2 is a schematic representation of an OSD menu provided by the broadcast receiving apparatus of FIG. 1;

FIG. 3 is a flow chart of a mode setting method of a broadcast receiving apparatus according to an embodiment of the present general inventive concept; and

FIG. 4 is a flow chart of a combined mode setting method of a broadcast receiving apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

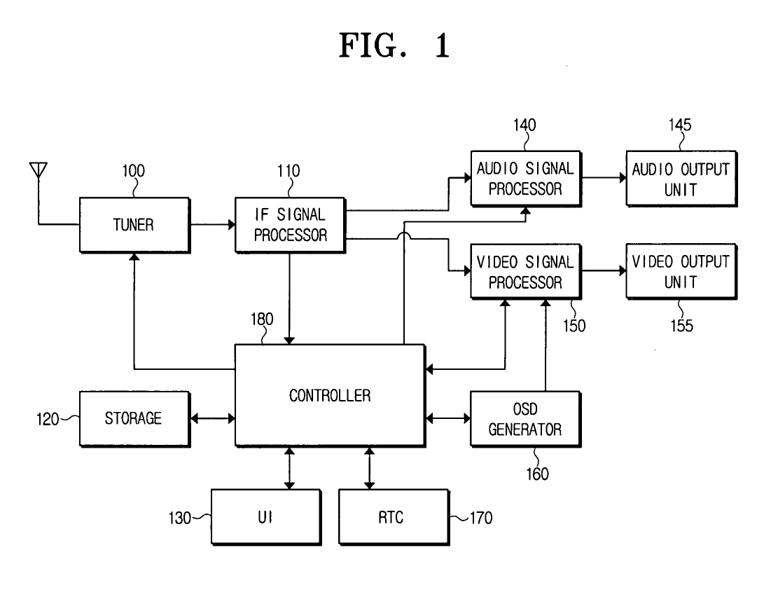

FIG. 1 is a schematic block diagram of a broadcast receiving apparatus according to an embodiment of the present general inventive concept. Referring to FIG. 1, the broadcast receiving apparatus includes a tuner 100, an IF signal processor 110, a storage unit 120, a user interface (UI) 130, an audio signal processor 140, an audio output unit 145, a video signal processor 150, a video output unit 155, an OSD (On Screen Display) generator 160, an RTC (Real Time Clock) 170, and a controller 180.

The tuner 100, under the control of the controller 180, selects a broadcast signal of a desired channel among RF (Radio Frequency) signals transmitted from a station.

The IF signal processor 110 generates an IF (Intermediate Frequency) signal from the RF signal received from the tuner 100. That is, the IF signal processor 110 demodulates a selected RF signal to a video signal, i.e., a VIF (Video Intermediate Frequency) signal, and an audio signal, i.e., an SIF (Sound Intermediate Frequency) signal.

The storage 120 stores an output mode, which is a combined mode of video and audio modes. Therefore, brightness, contrast, color, color-density, and sharpness values in the video modes, and treble and bass values in the audio modes are all stored the storage 120. Table 3 below illustrates the output mode.

TABLE 3

| Output | Bright- | | | Color- | Sharp- | | |
|---|---|---|---|---|---|---|---|
| mode | ness | Contrast | Color | density | ness | Treble | Bass |
| Standard | 80 | 80 | 0 | 50 | 80 | 50 | 50 |
| Sports | 80 | 70 | 5 | 55 | 80 | 50 | 55 |
| Movie | 75 | 85 | −10 | 60 | 70 | 55 | 55 |
| Music | 85 | 90 | 10 | 50 | 60 | 60 | 60 |
| News | 85 | 90 | 0 | 50 | 80 | 50 | 50 |
| User | 83 | 100 | −2 | 54 | 75 | 52 | 52 |

The standard, sports, movie, music, and news modes are pre-set modes that take into consideration program contents and surroundings. For instance, when a user selects the ‘movie’ mode, an output image and sound will be automatically set to the values listed in Table 3. In the ‘user’ mode, the user is able to adjust the brightness, contrast, color, color-density, and sharpness of the output image, and the treble and bass of the output sound to desired values.

The UI 130 receives from a remote controller (not shown) and a keypad (not shown) an external operation signal inputted by the user, and transmits the signal to the controller 180. The user, using the remote controller and the keypad, sets a channel number corresponding to a channel the user wants to watch, and a broadcasting time of the channel. In addition, the user can set the output mode applied to the broadcast signal of the channel, and the stereo and auto-multiplex functions as desired.

The audio signal processor 140 receives, under the control of the controller 180, the SIF signal from the IF signal processor 110, and can process the received SIF signal according to the designated output mode. Also, to output a stereo sound as a mono sound, the audio signal processor 140 selects one audio signal out of two stereo audio signals which are supposed to be output from two speakers, and processes the selected audio signal to a mono audio signal. Also, the audio signal processor 140 processes the audio signal to be outputted in a language the user selected using an audio-multiplex function.

The audio output unit 145 amplifies the audio signal from the audio processor 140 to a proper amplitude, and outputs the amplified audio signal.

The video signal processor 150 receives, under the control of the controller 180, the VIF signal from the IF signal processor 110, and separates the received VIF signal to a luminance signal and a color difference signal. Then, horizontal and vertical sync signals are isolated from the luminance signal, and transmitted to the controller 180. Meanwhile, an RGB signal is generated from the color difference signal. The video signal processor 150 processes the sync signals and the RGB signal according to the set video mode, and transmits processed video signals to the video output unit 155. Further, the video signal processor 150 may combine the processed video signals with an OSD menu, and transmits that combination to the video output unit 155.

The video output unit 155 displays on a screen the video signals and the OSD menu that are processed by the video processor 150.

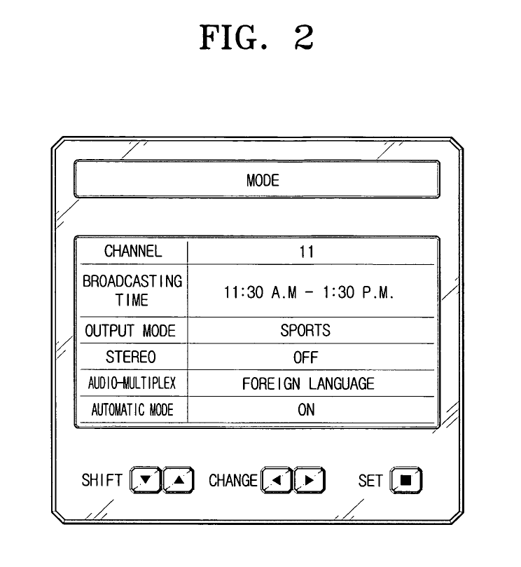

The OSD generator 160 generates data to display the OSD menu. The OSD menu is displayed on the screen for the user to control functions of the broadcast receiving apparatus. FIG. 2 is a schematic representation of the OSD menu provided by the broadcast receiving apparatus of FIG. 1. As shown in FIGS. 1 and 2, the OSD menu includes the channel number, broadcasting time, output mode, stereo function, audio-multiplex function, and automatic mode. Also, there is a message to be displayed on the screen, informing the user of whether or not the broadcast signal currently being received supports the stereo and audio-multiplex functions. For instance, when a broadcasting program of the broadcast signal does not support the stereo function, an OSD message, such as “The following program does not support the stereo function,” is outputted to the screen. In like manner, when the broadcasting program does not support the audio-multiplex function, an OSD message, such as “The following program does not support the audio-multiplex function,” is outputted to the screen.

The RTC (Real Time Clock) 170 provides the controller 180 with a present time and date. Although power is turned off, the RTC 170 keeps running if the broadcast receiving apparatus is in a stand-by mode. The RTC 170 is mainly used for a reservation function, such as setting a sleep mode. In the present general inventive concept, the RTC 170 is used for time reservation of a desired broadcasting program. When it is time for the broadcasting program the user wants to watch to start, the RTC 170 performs its designated function.

The controller 180 receives through the UI 130 an operation signal from an external source, and controls the broadcast receiving apparatus according to the operations signal. More specifically, the controller 180 reads from the storage 120 the output mode that is set by the user through the UI 130, and controls the video signal processor 150 and the audio signal processor 140 to process the video and audio signals.

In addition, when the user sets the channel number, broadcasting time, output mode, stereo function, and audio-multiplex function using the remote controller and keypad, the controller 180 stores these data in the storage 120. If the current time sensed through the RTC 170 coincides with a reserved broadcasting time, the controller 180 controls the tuner 100 to receive the broadcast signal of the selected channel. And, the controller 180 controls the video signal processor 150 and the audio signal processor 140 to apply the output mode, stereo function, and audio-multiplex function to the received broadcast signal.

As shown in FIG. 2, the OSD menu may set functions including the channel number, broadcasting time, output mode, stereo selection, audio-multiplex function, and automatic mode.

The user inputs the channel number of the channel next to a ‘Channel’ section, and the broadcasting time next to the ‘Broadcasting time’ section. Also, as shown in Table 3, for the output mode the user may select a combined mode of the video mode and the audio mode.

Although the user sets the stereo mode ‘on,’ the audio signal is output according to the broadcast signal format transmitted from a station. That is, if the incoming broadcast signal is in stereo, the audio signal will be outputted in stereo. If the incoming broadcast signal is in mono, however, the audio signal will be outputted in mono, and an OSD message, such as “The following program does not support the stereo function,” will be displayed on the screen.

On the other hand, when the user sets the stereo mode ‘off,’ the audio signal will be outputted in mono regardless of the broadcast signal format transmitted from the station. That is, when the incoming broadcast signal is in stereo, the audio signal processor 140 converts the audio signal to a mono mode signal, and outputs the mono mode signal. When the broadcast signal is in mono, the audio signal is outputted in mono.

The audio-multiplex function enables the user to select a language. For example, the user is able to choose Korean, a foreign language, or a dual language which outputs the Korean and foreign languages at the same time. Some programs do not support the audio-multiplex function. In such a case, a message, such as “The following program does not support the audio-multiplex function,” will be displayed on the screen.

Lastly, when the automatic mode is ‘on’, the output mode, the stereo function, and the audio-multiplex function are automatically applied to the broadcast signal of the selected channel at the set up time. In contrast, when the automatic mode is ‘off,’ those functions may not be applied to the broadcast signal according to the set mode.

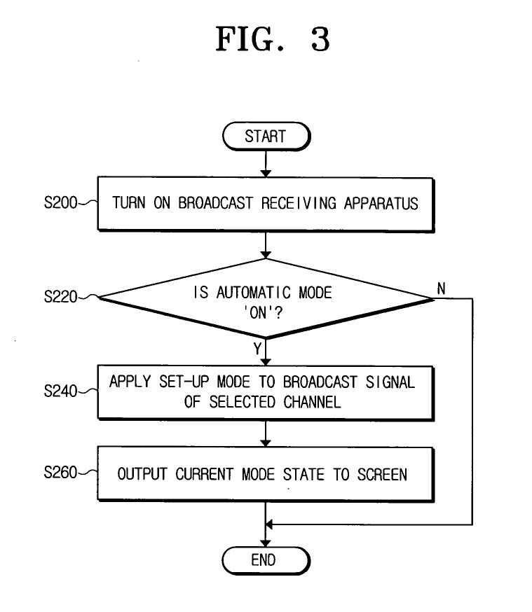

FIG. 3 is a flow chart of a mode setting method according to an embodiment of the present general inventive concept. Referring to FIGS. 1 through 3, a user sets the power of the broadcast receiving apparatus ‘on’ by operating the remote controller and keypad to turn on the broadcast receiving apparatus (operation S200).

If the automatic mode is set ‘on’ (operation S220), the controller 180 senses the current time through the RTC 170, and when it is time for a broadcasting program to start, the controller 180 controls the tuner 100 to receive the broadcast signal corresponding to the selected channel. Also, the controller 180 controls the audio signal processor 140 and the video signal processor 150 to apply the output mode, the stereo function, and the audio-multiplex function to the received broadcast signal (operation S240).

If a selected broadcasting program does not support the stereo and audio-multiplex functions, a message, such as “The following program does not support . . . ,” is displayed on the screen, informing the user which mode(s) the currently outputted broadcast signal is in (operation S260).

If the automatic mode is set ‘off’ (operation S220), although the channel number, broadcasting time, output mode, and stereo and audio-multiplex functions may have already been set up by the user, the output mode, the stereo function, and the audio-multiplex function are not applied to the currently outputted broadcast signal.

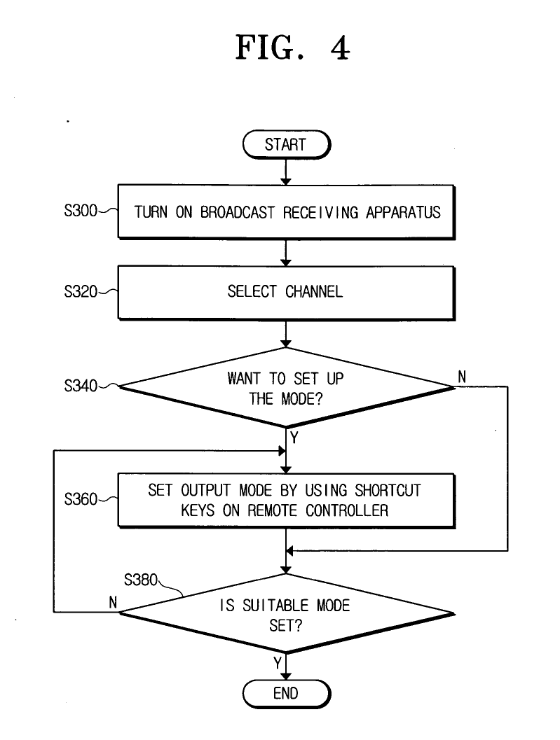

FIG. 4 is a flow chart of a combined mode setting method of a broadcast receiving apparatus according to an embodiment of the present general inventive concept. Referring to FIGS. 1 through 4, the user sets the power of the broadcast receiving apparatus ‘on’ by operating the remote controller and keypad to turn on the broadcast receiving apparatus (operation S300). The controller 180 receives through the UI 130 the channel number the user wants to watch, and controls the tuner 100 to receive the broadcast signal corresponding to the selected channel (operation S320).

If the user wants to set the output mode of the currently outputted broadcast signal (operation S340), the user can select a desired output mode by using the shortcut keys on the remote controller (operation S360). Then through the video and the audio output, the user finds out whether the set up output mode is suitable for the broadcasting program (operation S380). If the selected output mode is not suitable, the user can set a different output mode by using the shortcut keys on the remote controller.

As described above, according to the present general inventive concept a user is able to set a combined mode at a desired time, and allows a combined mode to be automatically performed later on. Also, the present general inventive concept enables the user to combine a video mode and an audio mode by operating a shortcut key on a remote controller, thereby increasing user convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A broadcast receiving apparatus, comprising:
a storage unit to store data required to set up a combined output mode of a video mode to process a video signal of a designated broadcast signal and an audio mode to process an audio signal of the broadcast signal;
a user interface to receive an external operation signal to set the combined output mode;
a video signal processor to process the video signal according to the combined output mode;
an audio signal processor to process the audio signal according to the combined output mode; and
a controller to read from the storage unit the data of the storage unit to set the combined output mode that is set up through the user interface, and to control the video signal processor and the audio signal processor to process the video signal and the audio signal in accordance with the read data of the combined output mode.

2. The apparatus according to claim 1, further comprising:
an on screen display generator to generate an on-screen display menu and an on-screen display message, wherein the on-screen display menu allows a user to set a channel number to select a channel, a broadcasting time of the selected channel, the combined output mode, a stereo function, an audio-multiplex function, and an automatic mode to automatically apply at least one of the combined output mode, the stereo function, and the audio-multiplex function to a broadcast signal of the channel at the broadcasting time, and the on-screen-display message indicates an execution state of the stereo function and/or the audio-multiplex function set to the channel.

3. The apparatus according to claim 1, wherein the user interface further receives the external operation signal to set at least one of a channel number, a broadcasting time of the selected channel, a stereo function, an audio-multiplex function, and an automatic mode to automatically apply at least one of the combined output mode, the stereo function, and the audio-multiplex function to the broadcast signal of the channel at the broadcasting time.

4. The apparatus according to claim 1, further comprising:
a real time clock unit to indicate a current time; and
a tuner to select a channel corresponding to the broadcast signal,
wherein if the current time coincides with a broadcasting time of the broadcast signal, the controller controls the tuner to select the channel and the audio signal processor to apply to the broadcast signal at least one of a stereo function and an audio-multiplex function.

5. The apparatus according to claim 1, wherein the video mode comprises at least one of a brightness value, a contrast value, a color value, a color-density value, and a sharpness value.

6. The apparatus according to claim 1, wherein the audio mode comprises at least one of a treble value and a bass value.

7. The apparatus according to claim 1, wherein the storage unit comprises a table containing the combined output mode according to a characteristic of the broadcast signal.

8. The apparatus according to claim 1, wherein the combined output mode comprises a pre-set mode and a user-set mode.

9. The apparatus according to claim 1, wherein the combined output mode forms a single table to contain the video mode and the audio mode.

10. A broadcast receiving apparatus, comprising:
a storage unit to store data representing a plurality of combined output modes, each combined output mode including a video mode to process a video signal of a designated broadcast signal and an audio mode to process an audio signal of the broadcast signal; and
a signal processor to process the video signal and the audio signal according to the combined output mode.

11. The apparatus according to claim 10, wherein the plurality of combined output modes comprises at least one of a standard mode, a sports mode, a movie mode, a music mode, a news mode, and a user mode.

12. The apparatus according to claim 11, wherein the user mode comprises one or more user-defined values relating to at least one of a brightness value, a contrast value, a color value, a color-density value, and a sharpness value.

13. The apparatus according to claim 10, wherein the video mode of each one of the plurality of combined output modes comprises at least one of a brightness value, a contrast value, a color value, a color-density value, and a sharpness value.

14. The apparatus according to claim 10, wherein the audio mode of each one of the plurality of combined output modes comprises at least one of a treble value and a bass value.

15. The apparatus according to claim 15, wherein the storage unit comprises a single table containing the plurality of combined output modes.

16. A broadcast receiving apparatus, comprising:
a signal processor to process a video signal and a audio signal of a broadcast signal; and
a controller to control the signal processor to process the video and audio signals according to a combined output mode of video mode and an audio mode.

17. A combined mode set-up method of a broadcast receiving apparatus, the method comprising:
storing data required to set up a combined output mode of a video mode to process a video signal of a designated broadcast signal and an audio mode to process an audio signal of the broadcast signal;
receiving an external operation signal to set up the combined output mode;
in accordance with the external operation signal, reading the data for setting up the combined output mode; and
in accordance with the read data of the combined output mode, processing the video signal and the audio signal.

18. The method according to claim 17, further comprising:
displaying an on-screen display menu enabling a user to set a channel number to select a channel, a broadcasting time of the selected channel, the combined output mode, a stereo function, an audio-multiplex function, and an automatic mode to automatically apply at least one of the combined output mode, the stereo function, and the audio-multiplex function to a broadcast signal of the channel at the broadcasting time; and
displaying an on-screen display message indicating an execution state of the stereo function and/or the audio-multiplex function set to the channel.

19. The method according to claim 17, wherein, the external operation signal receiving operation comprises receiving the external operation signal to set at least one of a channel number, a broadcasting time of the selected channel, a stereo function, an audio-multiplex function, and an automatic mode to automatically apply at least one of the combined output mode, the stereo function, and the audio-multiplex function to the broadcast signal of the channel at the broadcasting time.

20. The method according to claim 17, further comprising:
comparing a broadcasting time of the broadcast signal with a current time; and
if the current time coincides with the broadcasting time, selecting a channel corresponding to the broadcast signal and applying to the broadcast signal at least one of a stereo function and a audio-multiplex function of the audio mode of the combined output mode.

21. The method according to claim 17, wherein the video mode comprises at least one of a brightness value, a contrast value, a color value, a color-density value, and a sharpness value.

22. The method according to claim 17, wherein the audio mode comprises at least one of a treble value and a bass value.

23. A combined mode set-up method of a broadcast receiving apparatus, the method comprising:
storing data representing a plurality of combined output modes, each combined output mode including a video mode to process a video signal of a designated broadcast signal and an audio mode to process an audio signal of the broadcast signal; and
processing the video signal and the audio signal according to the combined output mode using a signal processor.

24. The method according to claim 23, wherein the storing of the data comprises forming a single table containing the plurality of combined output modes comprising at least one of a standard mode, a sports mode, a movie mode, a music mode, a news mode, and a user mode.

25. The method according to claim 24, wherein the forming of the table comprises providing the video mode of each one of the plurality of combined output modes having at least one of a brightness value, a contrast value, a color value, a color-density value, and a sharpness value.

26. The method according to claim 24, wherein the forming of the table comprises providing the audio mode of each one of the plurality of combined output modes having at least one of a treble value and a base value.
